(19) United States
(12) Patent Application Publication
(10) Pub. No.: US 2011/0025606 A1
(43) Pub. Date: Feb. 3, 2011

(54) METHOD AND APPARATUS FOR MEASURING KEYSTROKE

(75) Inventors: Frank J. Chvojcsek, West Dundee, IL (US); Keith A. McCready, Chicago, IL (US); David J. Mueller, Naperville, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: STENOGRAPH, L.L.C., Elmhurst, IL (US)

(21) Appl. No.: 12/763,525

(22) Filed: Apr. 20, 2010

Related U.S. Application Data
(60) Provisional application No. 61/273,014, filed on Jul. 29, 2009.

(51) Int. Cl. G06F 3/02

(52) U.S. Cl. 345/168; 178/18.01

(57) ABSTRACT

A writing apparatus comprises a housing and a keyboard mounted in the housing and having keys representing symbols of a language. Each key is moveable from a rest position. Sensors sense position of each key and develop a signal representing position of each key. A controller is operatively connected to the sensors for monitoring the signal. The controller is configured to determine if any of the keys are pressed by monitoring the position of each key and for any given key determining if an amount of change in position from the rest position for the given key is greater than a select movement amount and rate of change in position for the given key is greater than a selected velocity amount, and generating change in an output state for the given key responsive to the given key being pressed.

### CROSS REFERENCE TO RELATED APPLICATIONS

This application claims priority of provisional application No. 61/273,014 filed Jul. 29, 2009.

### FIELD OF THE INVENTION

This invention relates to a writing apparatus and, more particularly, to a method and apparatus for measuring keystroke.

### BACKGROUND OF THE INVENTION

Stenography is a widely used technique for recording the spoken word. The basic process includes two steps: (1) making a phonetic record of the speech being recorded, and (2) transcribing the phonetic record into a grammatical record such as, by way of example, an English language transcript. To ensure reliability and efficiency in the recording process, and to simplify the translating process, shorthand machines are frequently employed to produce the phonetic record. Such machines are especially useful when the recording is made over a relatively long period of time, for example in the courtroom or at a business meeting.

A widely used shorthand machine has a keyboard of twenty-two phonetically related symbols and characters which, to the skilled operator, provide the combinations necessary to record all English language words. Originally, the record produced by the machine was a paper tape on which the phonetic characters are printed. To record a word or part of a word, the operator strokes an appropriate combination or group of keys and the machine prints the characters simultaneously on an interval of the paper tape. The tape is advanced one interval after each group is recorded.

The shorthand machine provides both reliability and economy in the recording process. However, the translating process, while improved through the use of a shorthand machine, remains time consuming. The operator must read back the paper tape containing the phonetic characters and make a corresponding grammatical record.

U.S. Pat. Nos. 3,557,927; 4,205,351; and 3,832,733 describe improvements in the purely mechanical shorthand machine wherein the machine is modified to provide an electrical output in response to an operator engaging an appropriate group of keys. The electrical output may be recorded on a computer-readable medium such as a floppy disk which may be read by a computer. The computer performs the translation by comparing the input characters from the shorthand machine with a grammatical reference stored in the computer's memory. In its simplest form, the grammatical reference is a “dictionary” which relates all English language words to their phonetic or machine shorthand equivalents.

Computer programs that translate shorthand notes are referred to generally as computer-aided transcription (“CAT”) systems. CAT dictionaries are stored in a look-up table in memory, and the shorthand notes are translated by searching through the look-up table. The basic look-up table begins by storing a number of equivalents in its memory locations. Although powerful, known CAT systems have constraints. For example, the CAT system is reliant on proper interpretation of the group of keystrokes.

The term “keystroke” as used herein refers to the act of an operator engaging the keys of a shorthand machine with sufficient force to impress a symbol or character on the paper tape, and/or to produce an electrical output representing the symbol. A stenographic stroke is defined as a group of keys.

Known shorthand machines utilize mechanical interpretation of keystrokes. A key lever pushes an arm to switch a contact. As such, each key has a defined trip point when it is considered “pressed”. Certain known shorthand machines replace the mechanical switch with a Hall Effect sensor. These machines also use a select reference level to determine when an individual key is pressed and released. As is known, many stenographic strokes use a plurality of keys pressed simultaneously. Known shorthand writing machines require that all keys be released before looking for another stroke. Problems arise where one of the keys of a pending stroke is not released before one of the keys of the subsequent stroke is pressed.

Moreover, with known shorthand writing machines, the rest position may be modified. This and variations in each sensing position of each key may require that the machine be calibrated to insure proper operation.

The present invention is directed to further improvements in measuring keystroke for a writing apparatus.

### SUMMARY OF THE INVENTION

In accordance with the invention, a system and apparatus for measuring keystroke determines amount of change in position for a given key and rate of change in position for a given key.

There is disclosed in accordance with one aspect of the invention a writing apparatus comprising a housing and a keyboard mounted in the housing and having keys representing symbols of a language. Each key is moveable from a rest position. Sensors sense position of each key and develop a signal representing position of each key. A controller is operatively connected to the sensors for monitoring the signal. The controller is configured to determine if any of the keys are pressed by monitoring the position of each key and for any given key determining if an amount of change in position from the rest position for the given key is greater than a select movement amount and rate of change in position for the given key is greater than a selected velocity amount, and generating change in an output state for the given key responsive to the given key being pressed.

It is a feature of the invention that the controller is configured to change the output state of the given key to not pressed responsive to a change in direction of movement for the given key.

It is another feature of the invention that rest position of the keyboard is adjustable.

It is a further feature of the invention that the controller comprises a programmed processor.

It is yet another feature of the invention that the controller is configured to monitor for a group of keys being pressed simultaneously to define a pending stenographic stroke.

It is yet another feature of the invention that the controller generates an output indicating a completed stenographic stroke once the state of one of the pressed keys defining the pending stroke is changed to not pressed.

There is disclosed in accordance with another aspect of the invention a stenographic writing apparatus comprising a housing and a keyboard mounted in the housing and having a plurality of keys representing phonetic symbols of a language. Each key is moveable from a rest position individually or in groups to define word portions. A sensor is provided for each key. Each sensor senses position of an associated key and develops a signal representing position of the associated key. A controller is operatively connected to the sensors for monitoring the signals. The controller is configured to determine if any of the keys are pressed by monitoring the position of each key and for any given key determining if an amount of change in position from the rest position for the given key is greater than a select amount and rate of change in position for the given key is greater than a select velocity amount, and generating a change in an output state for the given key responsive to the given key being pressed.

There is disclosed in accordance with a further aspect of the invention a method of recording keystrokes in a writing apparatus comprising the steps of providing a housing; providing a keyboard mounted in the housing and having keys representing symbols of a language, each key being moveable from a rest position; sensing position of each key and developing a signal representing position of each key; and monitoring the signal and determining if any of the keys are pressed by monitoring the position of each key and for any given key determining if an amount of change in position from the rest position for the given key is greater than a select movement amount and rate of change in position for the given key is greater than a select velocity amount, and generating a change in an output state for the given key responsive to the given key being pressed.

Further features and advantages of the invention will be readily apparent from the specification and from the drawings.

### BRIEF DESCRIPTION OF THE DRAWINGS

FIG. 1 is a perspective view of a stenographic writing apparatus in accordance with the invention;

FIG. 2 is a side elevation view of one of the keys of the stenographic writing apparatus of FIG. 1;

FIG. 3 is a view, similar to FIG. 2, illustrating the key mounted to a frame;

FIG. 4 is a view similar to FIG. 3 illustrating a pair of keys, one pressed and one not pressed;

FIG. 5 is a block diagram of electrical and electronic circuitry for the writing apparatus of FIG. 1;

FIGS. 6a and 6b comprise an electrical schematic of a stenographic keyboard of the block diagram of FIG. 5;

FIG. 7 is a flow diagram illustrating a monitor key routine implemented by the processor of FIG. 5;

FIG. 8 is a flow diagram of a monitor stroke routine implemented by the processor of FIG. 5; and

FIG. 9 is a graphical illustration of key press information input to the processor of FIG. 5 for determining a stenographic strokes.

### DETAILED DESCRIPTION OF THE INVENTION

In accordance with the invention, a writing apparatus uses software to interpret keystrokes. Each key operates a lever arm having a magnet. A Hall Effect sensor is positioned proximate each magnet. Position of the magnet relative to the Hall Effect sensor varies a voltage supplied as an analog input to a programmed processor. Software operating the processor interprets the analog inputs for each key to interpret keystrokes.

The software senses both downward and upward movement of each key and transition levels. Rather than comparing sensed position to a target key position, the software compares movement of each key from a rest position, set by the user, and the velocity of such movement. The software records a key as pressed when the key moves a select amount from the rest position at a certain velocity. As such, nominal movement or movement at a slow velocity is not recorded as a key press. Also, the software determines that a key is no longer pressed when the key begins upward movement. This eliminates errors caused by the user failing to completely release each key which can result in missed input characters.

The software eliminates the necessity for the user to adjust sensitivity of each key. Instead, the machine is precalibrated. At the same time, the user can adjust rest position. The software can interpret the rest position and interpret the key press relative to the user selected rest position.

The software comprises a monitor key routine, for each key, which compares the downward velocity and distance from the rest position to consider a key pressed. Once a key is pressed then the key is released or not pressed as soon as upward movement is sensed. The software also comprises a monitor stroke routine which groups pressed keys in a pending stroke. Once a stroke is pending and no keys are pressed, i.e., they have all been released, then the pending stroke is accepted and cleared.

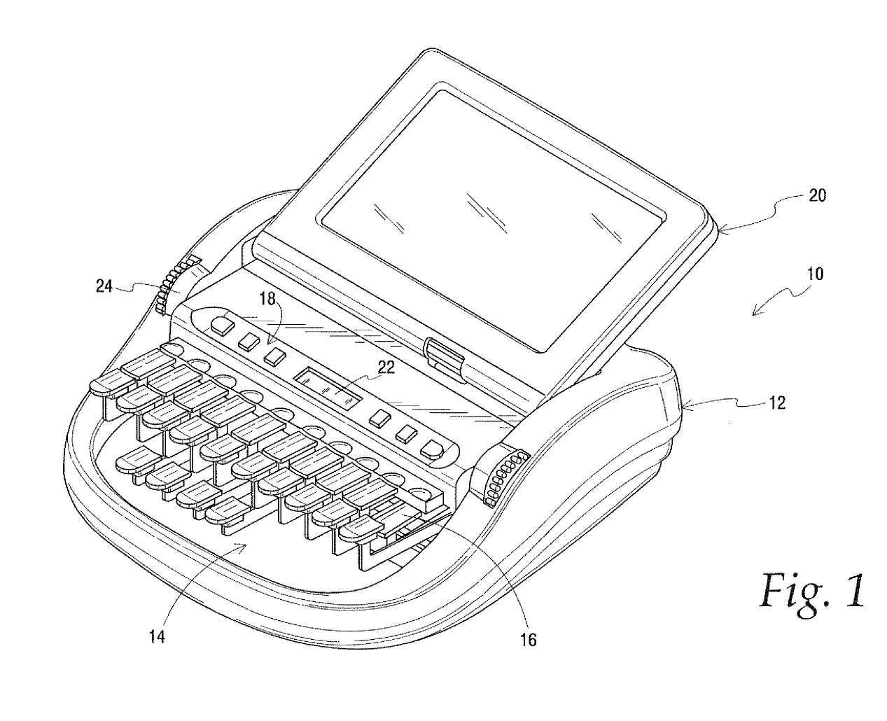

Referring to FIG. 1, a stenographic writing apparatus 10 in accordance with the invention is illustrated. The writing apparatus 10 comprises a housing 12 and a keyboard 14. The keyboard 14 is mounted in the housing 12 and has keys representing symbols of a language. Particularly, the keyboard 14 comprises a conventional stenographic keyboard having twenty two keys. One of the keys, labeled 16, is shown in a pressed position. The writing apparatus 10 also includes function keys 18, a primary LCD display 20 and a secondary LCD display 22. A rotary dial 24 is provided on the left side of the housing 12 for adjusting a rest position of the keyboard 14, as is known.

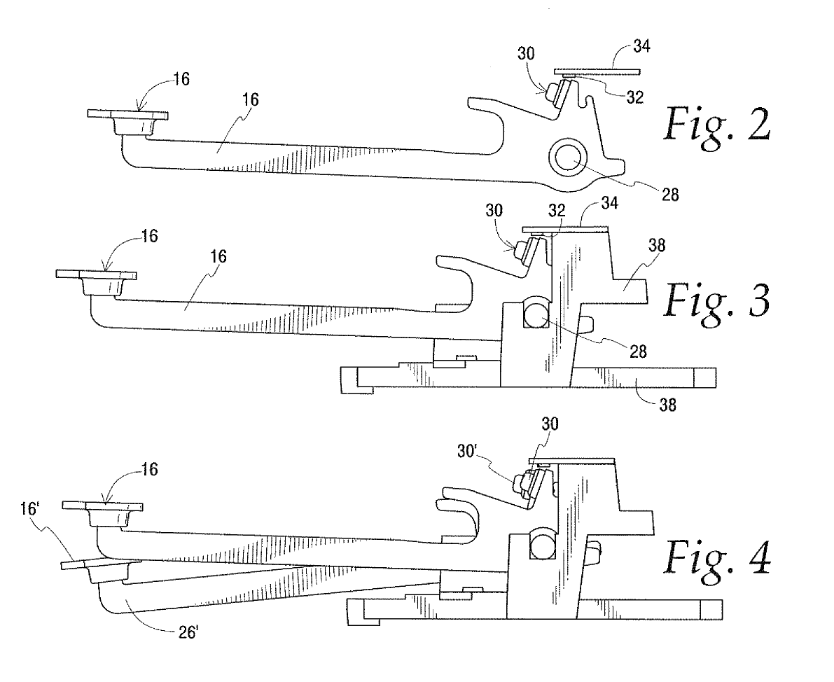

Referring to FIG. 2, the key 16 is illustrated in a rest position. In this illustration, other components of the writing apparatus 10 are removed for clarity. The key 16 is attached to the distal end of a lever arm 26 pivotal about a shaft 28. A magnet 30 is mounted to the lever arm 26 opposite the key 16. The magnet 30 is positioned proximate a conventional Hall Effect sensor 32 mounted to a circuit board 34. The Hall Effect sensor 32 generates an analog voltage representing position of the magnet 30 relative to the Hall Effect sensor 32. As is apparent, each of the twenty two keys of the keyboard 14 includes a lever arm, magnet and Hall Effect sensor.

FIG. 3 is similar to FIG. 2 and further illustrates a base 36 mounting a frame 38 pivotally supporting the shaft 28 so that the key 16 is moveable between a rest position, as shown, and an actuated position. Particularly, FIG. 4 illustrates the key 16 in the rest position and a second key 16′ and associated lever arm 26′ and magnet 30′ in a fully actuated position.

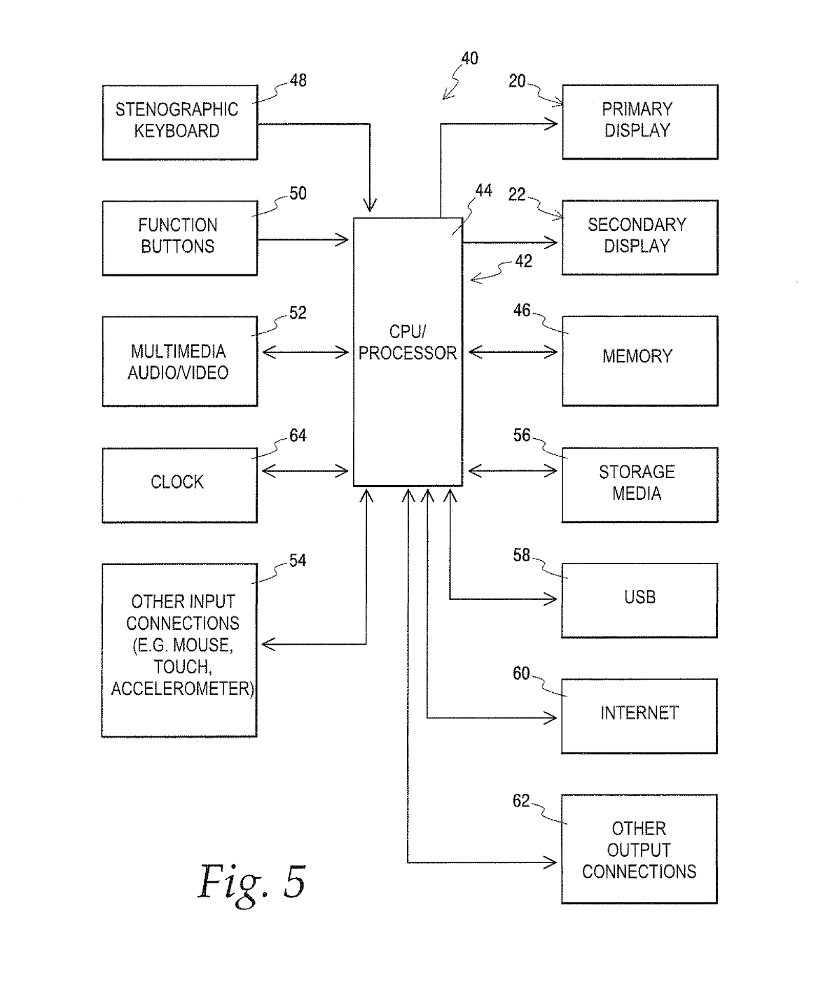

In accordance with the invention, a control system 40, see FIG. 5, is operable to determine whether or not each key of the keyboard 14 is pressed. The control system 40 measures the change in position for each key from the rest position and determines rate of change and uses this information to determine if an individual key is pressed. As is apparent, the position at which any given key is considered pressed is some position between the rest position and the fully actuated position.

The control system 40 includes a controller 42 comprising a processor 44 and associated memory 46 to define a programmed processor. The controller 42 is adapted to determine whether individual keys are pressed and similarly to determine the presence of a stenographic stroke which is then used by computer-aided transcription (“CAT”) software stored in the memory 46 to translate the strokes in a known manner. The present invention is not directed to the CAT software or how the information is subsequently used, but rather to methodology and apparatus for determining whether or not an individual key is pressed and whether or not to register a stenographic stroke. Thus, the CAT software is not discussed herein.

The illustrated embodiment of the invention comprises a stenographic writing machine. Nevertheless, the features described herein can also be used with other types of writing apparatus, as will be apparent to those skilled in the art.

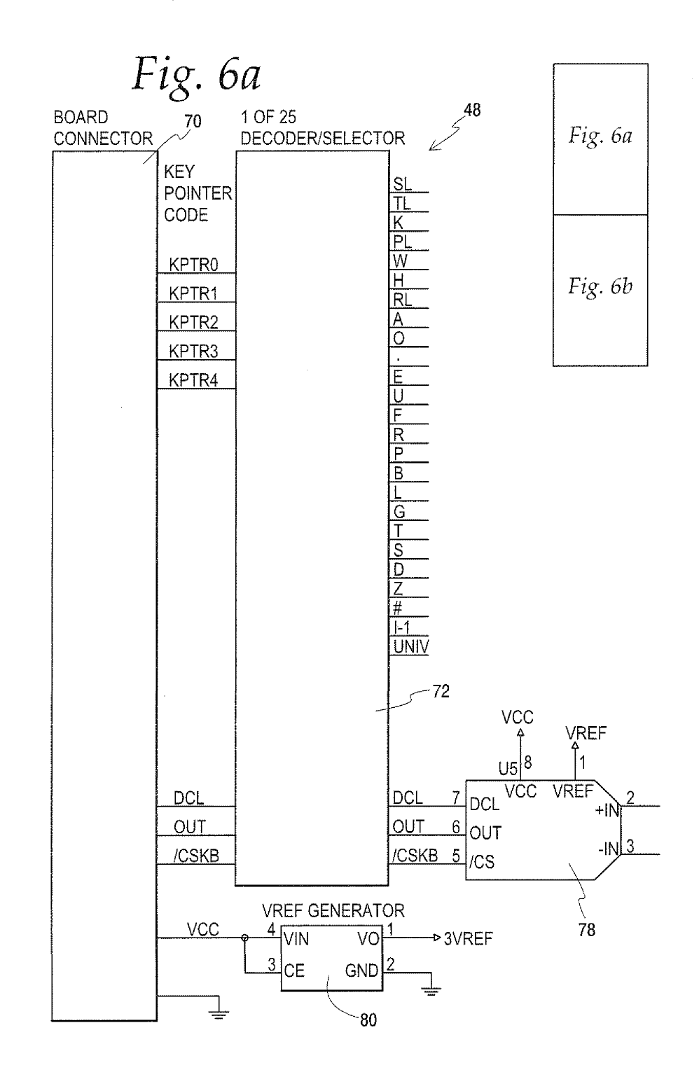

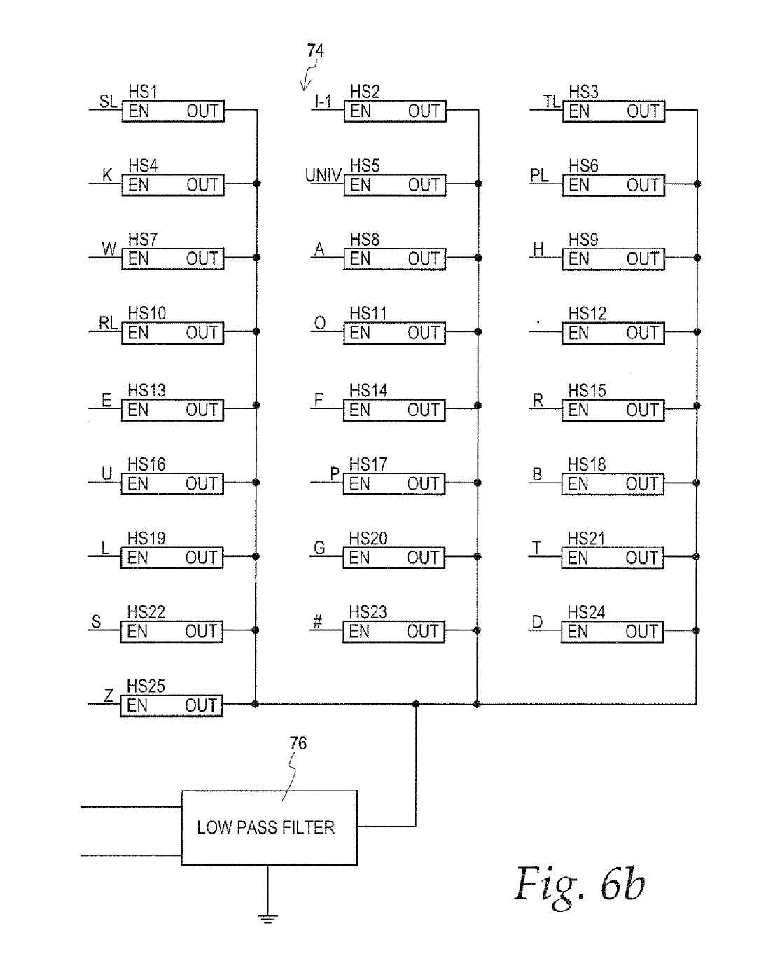

The control system 40 further comprises a stenographic keyboard block 48 connected to the processor 44. This block monitors the Hall Effect sensor for each key and is described in greater detail below relative to FIG. 6. The processor 44 is also connected to a function buttons block 50, associated with the function buttons 18, see FIG. 1, and to the primary display 20 and the secondary display 22. The processor 44 is also connected to other I/O connections such as a multimedia audio/video block 52 for connecting to multimedia devices, and other input connections block 54 for connecting to a mouse, touch pad, accelerometer, and the like and a storage media block 56 for connection to removable memory cards or the like. Additionally, the processor 44 is connected to a USB block 58, an interne block 60, and a block 62 representing other typical output connections and a clock circuit 64. Of the various I/O devices, only the keyboard block 48 is described in detail as the features of the other blocks may be of conventional design.

Referring to FIGS. 6a and 6b, a schematic diagram illustrates a circuit for the keyboard block 48. A board connector 70 is provided for connection to the processor 44. The board connector 70 is connected to a decoder/selector 72 which is connected to a Hall Effect sensor array 74. The Hall Effect sensor array 74 includes 25 Hall Effect sensors. The Hall Effect sensors are individually labeled HS1 through HS25. The decoder/selector 72 sequentially enables the individual Hall Effect sensors HS1-HS25 responsive to key pointer codes received from the processor 44 via the board connector 70. Each of the Hall Effect sensors HS1-HS25 is connected to a low pass filter 76 which is in turn connected to an analog to digital (A/D) converter 78 which is in turn connected to the decoder/selector 72 to provide Hall Effect sensor voltage information via the board connector 70 to the processor 44. A voltage reference generator 80 is also connected to the board connector 70 for generating a reference voltage for the A/D converter 78.

In accordance with the invention, the processor 44 is configured to read the analog voltages for each of the Hall Effect sensors HS#, where # represents one of the sensors 1-25. Particularly, each Hall Effect sensors HS# is individually enabled, and the voltage for the enabled Hall Effect sensor HS# is fed back through the low pass filter circuit 76 and converted to a digital value by the A/D converter 78 and input to the processor 44. The processor 44 measures the analog voltage for each Hall Effect sensor every two milliseconds. The processor uses a range of 1.5 v to 3.0 v to represent the range of position for an individual key, with 3.0 v being the rest position and 1.5 v being a voltage value set by calibration at the factory. Particularly, the rest position is adjustable, as discussed above relative to FIG. 1. The processor 44 can determine the rest position for each key based on the measured analog voltage values when none of the keys are being pressed. This eliminates the requirement to calibrate individual keys by a user.

The processor 44, for each key, measures the change in position from the rest position and likewise determines velocity or rate of change from the rest position by dividing the change in position by the amount of elapsed time since the key began moving from the rest position. This information is used to determine whether a key is pressed. Likewise, when the measured voltage changes to indicate that the key is being released, then the key is considered to be not pressed.

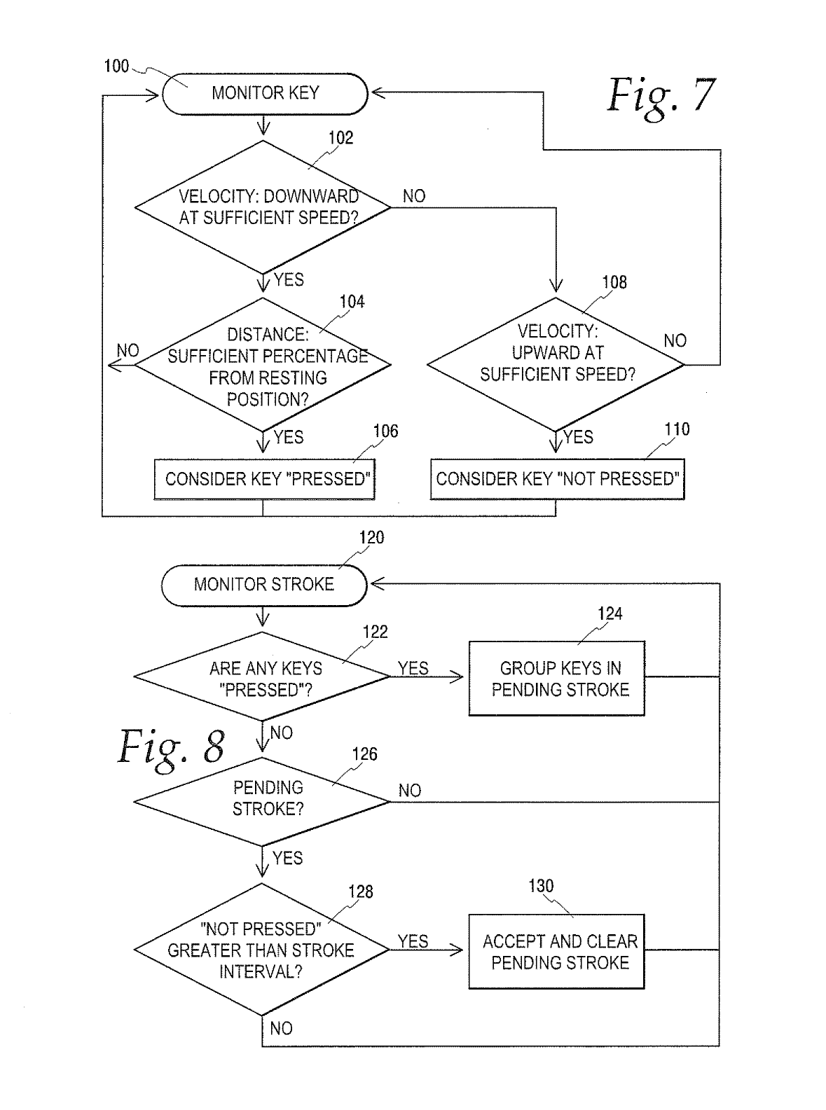

FIG. 7 illustrates a monitor key routine represented by a node 100 for monitoring position of each key and determining if an amount of change in position from the rest position for a given key is greater than a select movement amount and rate of change in position for the given key is greater than a select velocity amount. Particularly, this routine is performed every two milliseconds for each key of the keyboard 14. The flow diagram is described with reference to a given key, it being understood, that the same routine is repeatedly performed for each of the keys.

The monitor key routine begins at a decision block 102 which determines if the velocity of downward movement is at sufficient speed to indicate that a given key being monitored is being pressed. This is used to ignore slow movement such as might occur from a user resting a finger on an individual key. If the velocity is downward at a sufficient speed, then a decision block 104 determines if the distance moved is a sufficient percentage from the rest position. If not, then the program loops back to the node 100. If so, then the key is considered pressed at a block 106 and the routine returns to the node 100. Returning to the decision block 102, if the velocity was not downward at sufficient speed, then a block 108 determines if velocity is upward at sufficient speed. If not, then the program loops back to the node 100. If so, then the key is considered not pressed at a block 110 and the routine loops back to the node 100. Thus, with this routine, a given key is considered pressed only if the given key has moved downward at sufficient speed and has moved a sufficient distance from the rest position so that slow and small movement will not register. Likewise, once upward movement is at a sufficient speed to indicate that the key has been released, then the key will be changed from pressed to not pressed.

FIG. 8 illustrates a monitor stroke routine which begins at a node 120 for establishing whether or not a stenographic stroke has completed and should be stored. As is known, a stenographic stroke uses one or more keys pressed simultaneously. This routine begins at a block 122 which determines if any keys are pressed. This decision block uses the information from the monitor key routine of FIG. 7. If any keys are pressed, then the pressed keys are grouped in a pending stroke at a block 124. The program then loops back to the node 120. If there are no keys pressed, then a decision block 126 determines if there is a pending stroke. If not, then control loops back to the node 120. If there is a pending stroke, then a decision block 128 determines if all of the keys are not pressed greater than a pre-defined stroke interval. If so, then the stroke is accepted and the pending stroke cleared at a block 130. When the stroke is accepted, this information is used by the processor 44 and stored for use by the CAT software in a conventional manner.

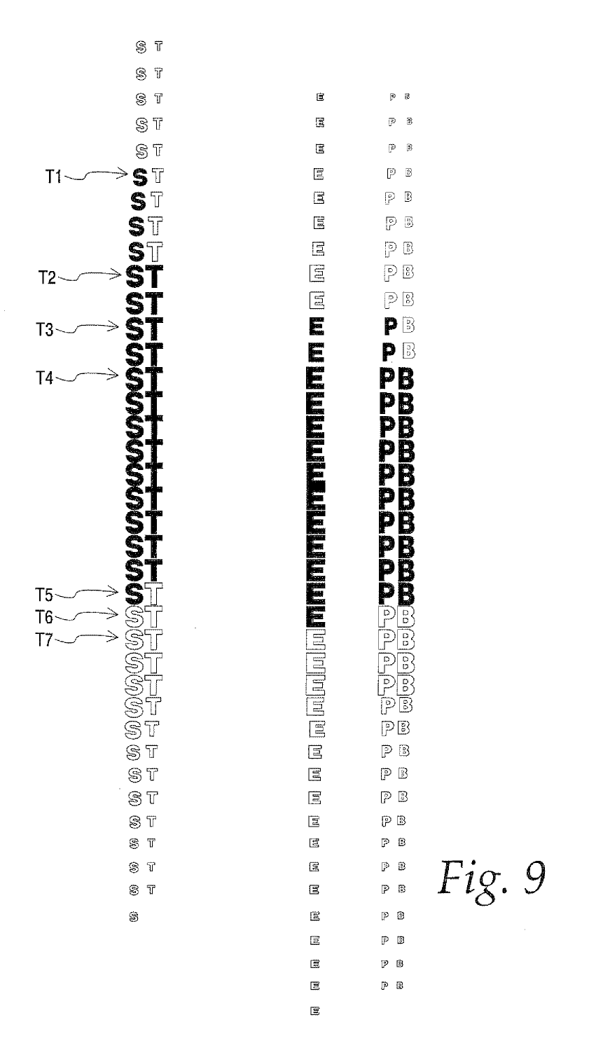

FIG. 9 visually illustrates operation of the monitor key routine of FIG. 7 and how the monitor stroke routine of FIG. 8 is used in the software by the processor 44. Each column represents one of the keys, with the columns for the S key, T key, E key, P key and B key illustrated. Others are not shown as those keys are not pressed in the example. Each row represents information read in a given cycle of the monitor key routine, going from top to bottom. The size of the letter represents the voltage being measured, i.e., amount of key movement from the rest position. The display also illustrates what direction the keys are moving. A letter increasing in size represents downward movement, while a letter decreasing in size represents upward movement.

When the letter is shown in solid, rather than outline, then that key is considered pressed responsive to the determination made in the flow diagram of FIG. 7. Thus, in this illustration, the S key is pressed beginning at a time T1, the T key is pressed beginning at a time T2, the E and P keys are pressed beginning at a time T3 and the B key is pressed beginning at a time T4. Likewise, using the monitor stroke routine of FIG. 8, a pending stroke would be present beginning at the time T1 and would continue thereafter, so that at a time T4, the keys S, T, E, P and B would be grouped in the pending stroke. Thereafter, at a time T5, the T key is considered not pressed. Subsequently, at a time T6, the S, P and B keys are considered not pressed and finally, at a time T7, the E key is considered not pressed. Once the E key is considered not pressed, at the time T7, then the pending stroke is accepted and cleared, as discussed above relative to the block 130 of FIG. 8.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention, a novel method and apparatus establishes that a keystroke has occurred by detecting and registering key strokes responsive to amount of movement of a key and rate of movement of a key from a rest position.

We claim:

1. A writing apparatus comprising:
a housing;
a keyboard mounted in the housing and having keys representing symbols of a language, each key being moveable from a rest position;
sensors for sensing position of each key and developing a signal representing position of each key; and
a controller operatively connected to the sensors for monitoring the signal, the controller being configured to determine if any of the keys are pressed by monitoring the position of each key and for any given key determining if an amount of change in position from the rest position for the given key is greater than a select movement amount and rate of change in position for the given key is greater than a select velocity amount, and generating a change in an output state for the given key responsive to the given key being pressed.

2. The writing apparatus of claim 1 wherein the controller is configured to change the output state of the given key to not pressed responsive to a change in direction of movement for the given key.

3. The writing apparatus of claim 1 wherein rest position of the keyboard is adjustable.

4. The writing apparatus of claim 1 wherein the controller comprises a programmed processor.

5. The writing apparatus of claim 1 wherein the controller is configured to monitor for a group of keys being pressed simultaneously to define a pending stenographic stroke.

6. The writing apparatus of claim 5 wherein the controller generates an output indicating a completed stenographic stroke once state of one of the pressed keys defining the pending stroke is changed to not pressed.

7. A stenographic writing apparatus comprising:
a housing;
a keyboard mounted in the housing and having a plurality of keys representing phonetic symbols of a language, each key being moveable from a rest position individually or in groups to define word portions;
a sensor for each key, each sensor for sensing position of an associated key and developing a signal representing position of the associated key; and
a controller operatively connected to the sensors for monitoring the signals, the controller being configured to determine if any of the keys are pressed by monitoring the position of each key and for any given key determining if an amount of change in position from the rest position for the given key is greater than a select movement amount and rate of change in position for the given key is greater than a select velocity amount, and generating a change in an output state for the given key responsive to the given key being pressed.

8. The stenographic writing apparatus of claim 7 wherein the controller is configured to change the output state of the given key to not pressed responsive to a change in direction of movement for the given key.

9. The stenographic writing apparatus of claim 7 wherein rest position of the keyboard is adjustable.

10. The stenographic writing apparatus of claim 7 wherein the controller comprises a programmed processor.

11. The stenographic writing apparatus of claim 7 wherein the controller is configured to monitor for a group of keys being pressed simultaneously to define a pending stenographic stroke.

12. The stenographic writing apparatus of claim 11 wherein the controller generates an output indicating a completed stenographic stroke once state of one of the pressed keys defining the pending stroke is changed to not pressed.

13. A method of recording keystrokes in a writing apparatus comprising the steps of:
providing a housing;
providing a keyboard mounted in the housing and having keys representing symbols of a language, each key being moveable from a rest position;
sensing position of each key and developing a signal representing position of each key; and
monitoring the signal and determining if any of the keys are pressed by monitoring the position of each key and for any given key determining if an amount of change in position from the rest position for the given key is greater than a select movement amount and rate of change in position for the given key is greater than a select velocity amount, and generating a change in an output state for the given key responsive to the given key being pressed.

14. The method of claim 13 wherein generating a change in an output state for the given key responsive to the given key being pressed further comprises changing the output state of the given key to not pressed responsive to a change in direction of movement for the given key.

15. The method of claim 13 wherein rest position of the keyboard is adjustable.

16. The method of claim 13 further comprising monitoring for a group of keys being pressed simultaneously to define a pending stenographic stroke.

17. The method of claim 16 further comprising generating an output indicating a completed stenographic stroke once state of one of the pressed keys defining the pending stroke is changed to not pressed.
